(19) United States
(12) Patent Application Publication
(10) Pub. No.: US 2015/0102112 A1
(43) Pub. Date: Apr. 16, 2015

(54) INTEGRATED WATER VALVE

(71) Applicant: Tsai-Chen YANG, Taichung City (TW)

(72) Inventor: Tsai-Chen YANG, Taichung City (TW)

(21) Appl. No.: 14/055,110

(22) Filed: Oct. 16, 2013

(51) Int. Cl. G05D 23/13

(52) U.S. Cl. CPC G05D 23/1346
USPC 236/12.2

(57) ABSTRACT

An integrated water valve includes an extendible temperature-regulation rod disposed in a main body. Temperature of water can be adjusted by moving the temperature-regulation rod to change ratio of cold water and hot water. Also, water flow can be controlled by rotating the main body with respect to a seat at the bottom thereof. Thus, the present invention can be adapted for adjusting water flow and water temperature.

### BACKGROUND OF THE INVENTION

1. Field of the Invention

The present invention relates to a water valve, more especially to a water valve having temperature-regulation structure and switching structure.

2. Description of the Prior Art

A conventional temperature-regulation water valve is disclosed in patent TW 514182. In this disclosure, a rotation switch is disposed above a valve seat having an outlet, and the rotation switch is screwed with a driven sleeve having a through hole. A receiving room is formed between the driven sleeve and the valve seat. A water room is enclosed by the driven sleeve, and a driving rod with a spring is disposed on an intermediate plate. Another spring and a sliding piece are disposed in a valve body having cold water inlet and hot water inlet. The sliding piece is formed with plural holes and a seat. The valve body is arranged below the valve seat, and an end of the driving rod is disposed on the seat of the sliding piece. Thereby, the driving rod may extend or shrink when water temperature changes to adjust ratio of cold water and hot water to regulate temperature of water. Also, one can rotate the rotation switch to adjust temperature of water. However, this structure must be utilized with a faucet. As a result, the whole structure is too bulky and is difficult to install.

### SUMMARY OF THE INVENTION

The main object of the present invention is to provide an integrated water valve which is able to regulate water flow and water temperature.

To achieve the above and other objects, an integrated water valve of the present invention includes a main body, a seat, a temperature-regulation structure, a control structure, and a housing.

The main body has an internal surface, an external surface, and a covering member located at a top thereof. A first channel and a second channel are formed between the internal surface and external surface. The internal surface encloses a cavity and is formed with a first inlet hole and a second inlet hole. The first channel and the second channel communicate with the cavity via the first inlet hole and the second inlet hole respectively.

The seat is rotatably disposed on a bottom of the main body and has a outlet hole, a hot water inlet hole, and a cold water inlet hole. The cavity communicates with exterior via the outlet hole. The first channel communicates with the hot water inlet hole, and the second channel communicates with the cold water inlet hole. The first channel alternatively discommunicates with the hot water inlet hole and the second channel alternatively discommunicates with the cold water inlet hole when the seat is rotated with respect to the main body.

The temperature-regulation structure includes an extendible temperature-regulation rod, a shielding element, and a first elastic element which are all disposed in the cavity. The temperature-regulation rod is connected with the shielding element, and the temperature-regulation rod and the shielding element are able to move along the main body up and down. The shielding element alternatively shields the first inlet hole and the second hole. Sizes of openings of the first inlet hole and the second inlet hole are able to be adjusted by moving the shielding element with respect to the main body. The first elastic element pushes one of the temperature-regulation rod and the shielding element in order to move it upward.

The control structure includes a control axle, a driven element, a second elastic element, and an abutting piece. The control axle is rotatably inserted through the covering member. The driven element is movably disposed on the covering member and is threaded to the control axle. The driven element encloses a space, and the second elastic element and the abutting piece are disposed in the space. The second elastic element pushes the abutting piece to make the abutting piece abut against the temperature-regulation rod.

The housing covers the main body and the seat. The housing and the main body have corresponding stepped faces to abut against each other. The seat and the housing have corresponding buckle portion and buckle groove to be buckled to each other.

Thereby, water flow can be adjusted by rotating the main body with respect to the seat, and water temperature can be adjusted by changing ratio of hot water and cold water by the temperature-regulation structure.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing of the present invention;

FIGS. 2 and 3 are profile of the present invention;

FIG. 4 is a stereogram of the present invention.

### DETAILED DESCRIPTION OF THE PREFERRED EMBODIMENTS

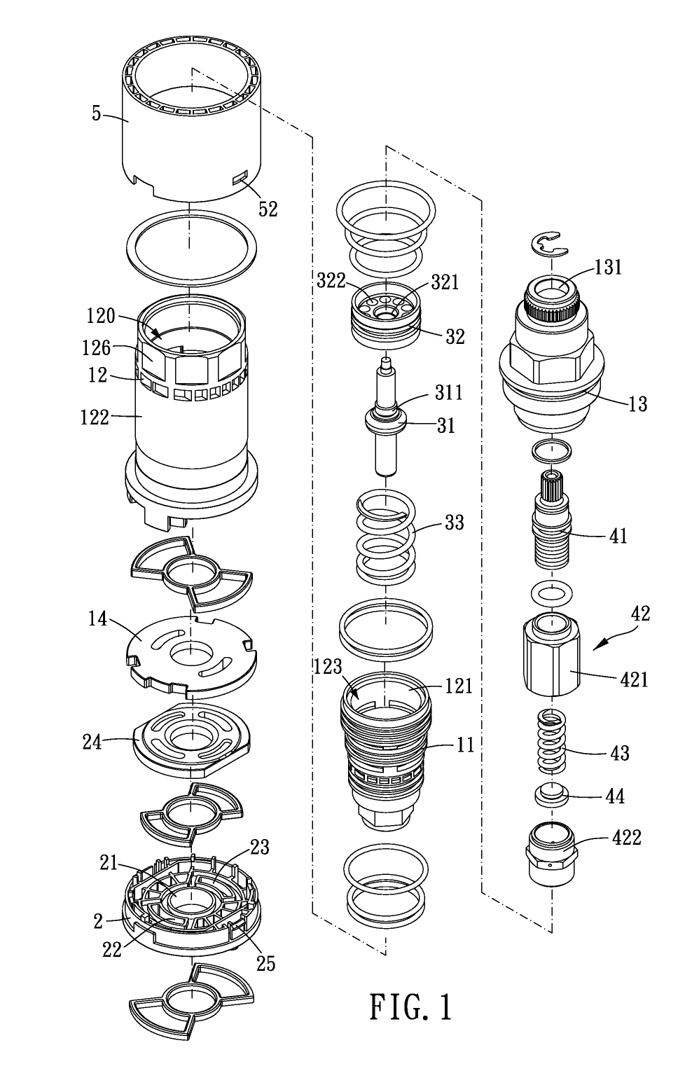

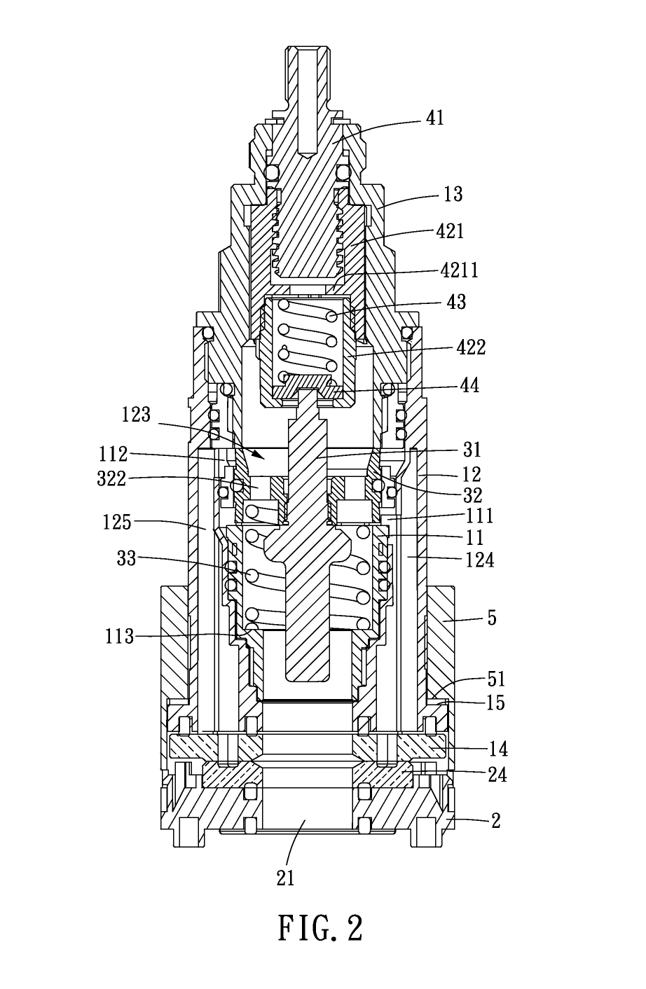

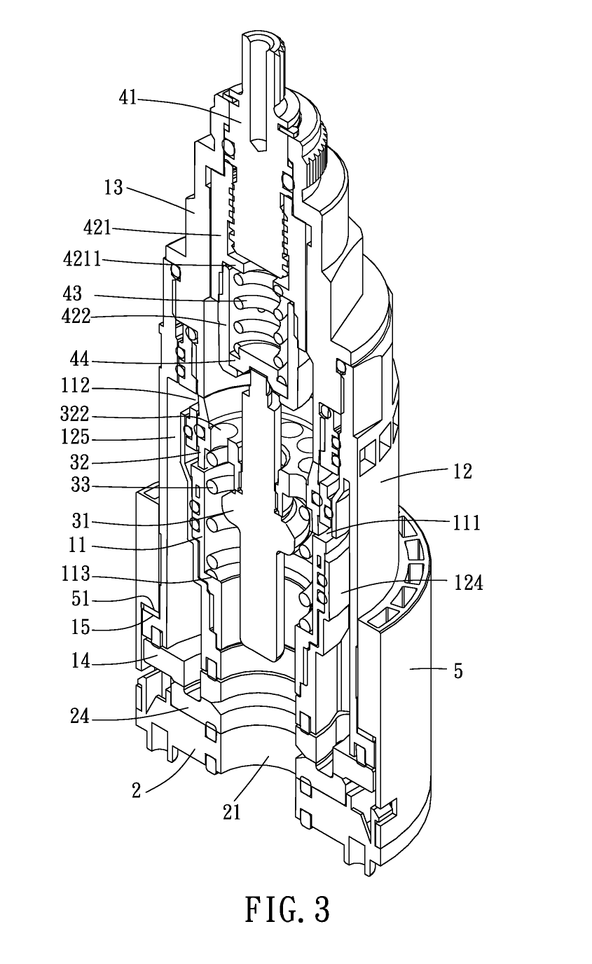

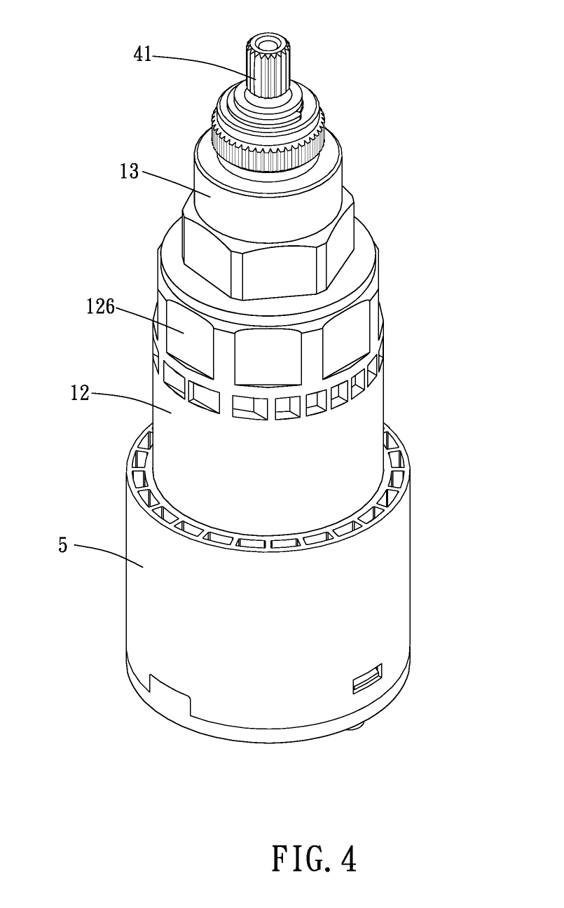

Please refer to FIG. 1 to FIG. 4 for a major embodiment of the present invention. The integrated water valve of the present invention includes main body, a seat 2, a temperature-regulation structure, a control structure, and a housing 5.

The main body includes an inner body 11 and an outer body 12. The outer body 12 has an external surface 122 and encloses a receiving room 120. The inner body 11 has an internal surface 121, and the internal surface 121 encloses a cavity 123. The inner body 11 is disposed in the receiving room 120 of the outer body 12. A first channel 124 and a second channel 125 are formed between the internal surface 121 and the external surface 122. The first channel 124 and the second channel 125 extend respectively from a bottom of the outer body 12 toward a top of the outer body 12. The inner body 11 has a first inlet hole 111 and a second inlet hole 112 which are different in height. The internal surface 121 of the inner body 11 is formed with a stepped surface 113. The first inlet hole 111 and the second inlet hole 112 positionally correspond to the first channel 124 and the second channel 125 respectively. The first channel 124 and the second channel 125 communicate with the cavity 123 via the first inlet hole 111 and the second inlet hole 112 respectively. Besides, a covering member 13 is disposed on a bottom of the main body. The covering member 13 is formed with a through hole 131. In addition, the outer body 12 has driving portion 126 which has a polygonal shape. The driving portion 126 is adapted for a handle connecting to.

The seat 2 is rotabaly disposed on a bottom of the main body. The seat 2 has an outlet hole 21, a hot water inlet hole 22, and a cold water inlet hole 23. The cavity 123 communicates with exterior via the outlet hole 12. The first channel 124 communicates with the hot water inlet hole 22, and the second channel 125 communicates with the cold water inlet hole 23. Specifically, the first channel 124 and the second channel 125 alternatively communicate with the hot water inlet hole 22 and the cold water inlet hole 23 respectively when the seat 2 is rotated with respect to the main body. In other words, when the seat 2 is rotated with respect to the main body, the first channel 124 is alternatively deviated from the hot water inlet hole 22 so that the first channel 124 discommunicates with the hot water inlet hole 22. Similarly, the second channel 125 is alternatively deviated from the cold water inlet hole 23 so that the second channel 125 discommunicates with the cold water inlet hole 23. Also, water flow can be adjusted by the rotation angle. Besides, to improve sealing between the seat 2 and the main body, the main body is disposed with a ceramic movable piece 14, and the seat 2 is disposed with a ceramic stationary piece 24. The movable piece 14 and stationary piece 24 abut against each other for sealing.

The temperature-regulation structure includes an extendible temperature-regulation rod 31, a shielding element 32, and a first elastic element 33. The temperature-regulation rod 31, the shielding element 32, and the first elastic element 33 are all disposed in the cavity 123. The temperature-regulation rod 31 and the shielding element 32 are connected together and are able to move along the main body up and down. Specifically, the shielding element 32 is movably disposed between the inner body 11 and the covering member 13. The shielding element 32 is formed with an annular groove on a wall of the coupling hole 321. The temperature-regulation rod 31 is formed with a rib 311 adapted for coupling with the annular grove so that the temperature-regulation rod 31 and the shielding element 32 are linked-up together. The shielding element 32 shields the first inlet hole 111 and the second inlet hole 112, and sizes of openings of the first inlet hole 111 and the second inlet hole 112 are able to be adjusted by moving the shielding element 32 with respect to the main body. More specifically, when the shielding element 32 is moved toward a specific direction, one of the openings of the first inlet hole 111 and the second inlet hole 112 is enlarged, and the other one of the openings of the first inlet hole 111 and the second inlet hole 112 is reduced. Thus, ratio of flow of the first inlet hole 111 and the second inlet hole 112 can be adjusted. Besides, the first elastic element 33 pushes the temperature-regulation rod 31 or the shielding element 32 upward. In the present embodiment, the first elastic element 33 is arranged between the stepped face 113 and the shielding element 32.

The control structure includes a control axle 41, a driven element 42, a second elastic element 43, and an abutting piece 44. The control axle 41 is rotatably disposed on the covering member 13. Specifically, an end of the control axle 41 extends above the covering member 13 for controlled by users. Optionally, the control axle can be disposed with a handle. The driven element 42 is movably disposed in the covering member 13 and is screwed with the control axle 41. Specifically, the driven element 42 includes a first portion 421 and a second portion 422. An end of the first portion 421 is screwed with the control axle 41 (the control axle 41 is formed with external threads, and the first portion 421 is formed with corresponding internal threads), and the other end of the first portion 421 is connected with the second portion 422. Practically, the first portion 421 is tube-shaped, each end of the first portion 421 is formed with a sleeve hole. The two ends of the first portion 421 are sleeved onto the control axle 41 and the second portion 422 respectively. Besides, the first portion 421 is formed with a propping portion 4211 between the two sleeve holes. The second portion 422 encloses a space where the second elastic element 43 and the abutting piece 44 are disposed. The second portion 422 is further formed with a hole on the bottom thereof wherein the hole communicates with the space of the second portion 422. The temperature-regulation rod 31 is inserted through the hole of the second portion 422 and abuts against the abutting piece 44. The second elastic element 43 is arranged between the propping portion 4211 of the first portion 421 and the abutting piece 44 so as to push the abutting piece 44 to abut against the temperature-regulation rod 31. More specifically, the elastic coefficient of the second elastic element 43 is larger than the elastic coefficient of the first elastic element 33, and the temperature-regulation rod 31 and the abutting piece 44 are kept abutting against each other due to the first elastic element 33 and the second elastic element 43. Thereby, the temperature-regulation rod 31 and the shielding element 32 are maintained at a specific position.

The housing 5 partially or entirely covers the main body and the seat 2. In the present embodiment, the housing 5 partially covers the main body and entirely covers the seat 2. The housing 5 and the main body are formed with corresponding stepped faces 51, 15 to abut against each other. In addition, the seat 2 and the housing 5 have corresponding buckle portion 25 and buckle groove 52 to be coupled to each other.

In use, hot water and cold water enter via the hot water inlet hole 22 and the cold water inlet hole 23. Thereafter, hot water flows through the first channel 124 and enters the cavity 123 via the first inlet hole 111, and cold water flows through the second channel 125 and enters the cavity 123 via the second inlet hole 112. Hot water and cold water are mixed in the cavity, and the mixed water is discharged via the outlet hole 21.

One can rotate the main body with respect to the seat 2 by pulling the handle to drive the driving portion 126 of the outer body 12. When the inlet holes and the channels are deviated, water flow is turned off. That is, water flow can be adjusted by the outer body 12.

Furthermore, one can rotate the control axle 41 to drive the driven element 42 moving. In other words, the control axle 41 and the driven element 42 are screwed to each other so that the driven element 42 may be moved upward or downward when the control axle 41 is rotated. Thereafter, the abutting piece 44 is driven to push the temperature-regulation rod 31 in order to move the shielding element 32 so as to adjust ratio of cold water and hot water. Thus, temperature of water can be easily adjusted. That is, one can rotate clockwise or counterclockwise to adjust temperature of water.

The temperature-regulation rod 31 is extendible and deformable, more especially, the extendible portion is located at an end of the temperature-regulation rod 31 abutting against the abutting piece 44. Therefore, the temperature-regulation rod 31 may expand when temperature of water increases and shrink when temperature of water decreases. That is, the length of the temperature-regulation rod varies at different temperature of water. When the length of the temperature-regulation rod 31 changes, the shielding element 32 is slightly moved upward or downward to adjust temperature of water. More specifically, when the temperature of water in the cavity 123 is too high or too low, the temperature-regulation rod 31 may automatically drive the shielding element 32 moving to regulate ratio of cold water flow and hot water flow so as to keep water at a predetermined temperature.

On the contrary, the present invention is able to adjust water flow and water temperature. Also, structure of the present invention is simple so as to be installed easily.

What is claimed is:

1. An integrated water valve, including:
a main body, having an internal surface, an external surface, and a covering member disposed on a top thereof, a first channel and a second channel being formed between the internal surface and the external surface, the internal surface enclosing a cavity and having a first inlet hole and a second inlet hole, the first channel and the second channel communicating with the cavity via the first inlet hole and the second inlet hole respectively;
a seat, rotatably disposed on a bottom of the main body, the seat including an outlet hole, a hot water inlet hole, and a cold water inlet hole, the cavity communicating with exterior via the outlet hole, the first channel communicating with the hot water inlet hole, the second channel communicating with the cold water inlet hole, the first channel alternatively discommunicating with the hot water inlet hole and the second channel alternatively discommunicating with the cold water inlet hole when the seat is rotated with respect to the main body;
a temperature-regulation structure, including an extendible temperature-regulation rod, a shielding element, and a first elastic element, the temperature-regulation rod, the shielding element, and the first elastic element being disposed in the cavity, the temperature-regulation rod and the shielding element being linked together and being movable up and down, the shielding element shielding the first inlet hole and the second inlet hole, sizes of openings of the first inlet hole and the second inlet hole being able to be regulated by moving the shielding element with respect to the main body, the first elastic element pushing one of the temperature-regulation rod and the shielding element upward;
a control structure, including a control axle, a driven element, a second elastic element, and an abutting piece, the control axle being rotatably inserted into the covering member, the driven element being movably disposed on the covering member and being threaded to the control axle, the second elastic element and the abutting piece being disposed in a space enclosed by the driven element, the second elastic element pressing the abutting piece to make the abutting piece abut against the temperature-regulation rod;
a housing, covering the main body and the seat, the housing and the main body having corresponding stepped faces abutting against each other, the seat and the housing having corresponding buckle portion and groove buckled to each other.

2. The integrated water valve of claim 1, wherein the first channel and the second channel extend respectively from the bottom of the main body toward the top of the main body.

3. The integrated water valve of claim 1, wherein the shielding element is formed with a coupling hole and at least one aperture, the temperature-regulation rod is inserted through the coupling hole.

4. The integrated water valve of claim 3, wherein the shielding element is formed with an annular groove on an inner wall of the coupling hole, the temperature-regulation rod is formed with a rib to be received in the annular groove.

5. The integrated water valve of claim 1, wherein an elastic coefficient of the second elastic element is larger than an elastic coefficient of the first elastic element.

6. The integrated water valve of claim 1, wherein the driven element includes a first portion and a second portion, an end of the first portion is threaded to the control axle, another end of the first portion is connected to the second portion, the second portion enclosing a space, the second portion is formed with a hole on a bottom thereof which communicates with the space enclosed by the second portion, the temperature-regulation rod is inserted through the hole of the second portion and abuts against the abutting piece, two opposite ends of the second elastic element abut against the first portion and the abutting piece respectively.

7. The integrated water valve of claim 6, wherein two sleeve holes are formed at the two ends of the first portion respectively and are sleeved onto the control axle and the second portion respectively, the first portion has a propping portion between the two sleeve holes, the two ends of the second elastic element abut against the propping portion and the abutting piece respectively.

8. The integrated water valve of claim 1, wherein the main body includes an inner body and an outer body, the outer body encloses a receiving room and has a driving portion which is polygonal, the inner body has the internal surface and is disposed in the receiving room of the outer body, the inner body has the first inlet hole and the second inlet hole which are different in height, the shielding element is movably disposed between the inner body and the covering member.

9. The integrated water valve of claim 8, wherein the internal surface of the inner body is formed with a stepped face, two ends of the first elastic element abut against the stepped face and the shielding element respectively.
